(19) United States
(12) Patent Application Publication
(10) Pub. No.: US 2011/0231226 A1
(43) Pub. Date: Sep. 22, 2011

(54) SYSTEM AND METHOD TO PERFORM SURVEYS

(75) Inventor: Robert N. Golden, Kirkland, WA (US)

(73) Assignee: PINNION, INC., Kirkland, WA (US)

(21) Appl. No.: 13/069,231

(22) Filed: Mar. 22, 2011

Related U.S. Application Data
(60) Provisional application No. 61/316,161, filed on Mar. 22, 2010.

(51) Int. Cl. G06Q 10/00; G06Q 40/00

(52) U.S. Cl. 705/7.32; 705/1.1; 705/30; 705/39

(57) ABSTRACT

Embodiments of computing servers host web page pages that deliver information to users. The information relates to the acceptance of survey topics and questions to be asked, the formation of surveys from the topics and questions, and the communication of the surveys to particular devices such as mobile devices. Additionally, embodiments of the computing servers accept survey responses from the devices, facilitate compensation to the responder, process the responses, and communicate information related to the survey responses.

### BACKGROUND OF THE INVENTION

1. Technical Field

This disclosure generally relates to computing servers that host web pages for delivering information to users related to surveys and, more particularly, to accessing the information with mobile devices.

2. Description of the Related Art

People conduct surveys for economic development, civic planning, politics, and many other business and personal reasons. For example, businesses conduct surveys to gauge potential consumer interest in particular products or services. Government and political officials conduct surveys to understand constituent attitudes, desires, levels of satisfaction or frustration, political leanings, and other things. In some cases, people conduct surveys to communicate information.

Prior to creating a survey, one or more people determine that there is a need or desire to gather particular information from a particular group of people. The one or more people that desire the information are a “survey requestor.” The survey requestor believes that the particular group of people who have the desirable information also have at least one common characteristic that is related to the particular information desired. The relationship between the common characteristic and the information allow the survey requestor to at least generally identify a target group of potential survey participants.

In conventional business, political, healthcare, or other methodologies, the survey requestor contacts a survey provider. In many cases, the survey provider is also the survey host that administers the survey to participants.

The survey provider elicits information from the survey requestor; often in an interactive way. For example, in some cases, the survey requestor may simply convey the purpose of the survey and one or more topics to the survey provider, but more commonly, the survey requestor and the survey provider work together to identify particular information that the survey requestor is trying to gather. In addition, the survey requestor and survey provider also identify a particular target group of survey participants and methodologies that may be used to increase the chances of making the survey a success.

Survey providers generally use complex, expensive, private and inflexible methods for creating and conducting surveys. Highly skilled people are employed by the survey providers to gather information from the survey requestor and to draft precisely focused survey questions. The survey questions are designed to elicit responses that reveal certain information about the survey participant. For example, particular attitudes, beliefs, perceptions, and viewpoints are all types of information that survey requestors generally find useful.

After the questions are drafted, skilled people or even automated systems contact potential survey participants. The survey participants may be contacted via many methods such as the mail, telephone, email, face-to-face questioning, Internet websites, or other means. The survey participants provide answers to survey questions, and the answers provided constitute raw data.

After raw data is collected from the survey participants, the data is conventionally processed by highly skilled people or sophisticated computer programs to produce a resulting composite data set. The data set, in full or in part, is communicated to the requestor of the survey.

In other cases, surveys are created by very simple techniques. A simple survey can be created inexpensively and quickly, although the quality of the survey questions and results is typically lower than that of a traditional survey. Nevertheless, quick and inexpensive surveys are available.

To provide a simple survey that is both quick and inexpensive to produce, computing servers are programmed to enable survey authors to enter their own questions. Generally, the computing server has resident software that presents a user interface to a survey author. The survey author drafts questions that will be included in the survey. Upon completion of the survey drafting, the survey is made available to survey participants.

After making the survey available to participants, the survey author will generally invite the participants to access the survey via a browser. In many cases, the invitation is in the form of an email sent by the survey author or his representative. When participants access and complete the survey, the survey author receives information related to how particular questions on the survey have been answered. Typically, the survey author has access to both individual response and aggregate results from many participants.

It has been realized that with respect to traditional surveys, both complex and simple systems that are currently used have many shortcomings. For example, complex surveys are expensive and take a long time to produce. The survey requestor may provide input into the questions, but often it is the expertise of the survey provider that determines which questions will be asked, the order of the questions, the number of questions, the manner of conducting the survey and many other details.

Simple surveys, as traditionally implemented, have disadvantages as well. A survey requestor is permitted to author the survey questions and determine the order of questions, but there is generally little if any help provided. Often, simple survey questions are ambiguous, unclear, or unable to provide the information that the survey requestor is looking for.

Other disadvantages of traditional surveys are related to survey participants. Participants may be disinterested in a survey topic or even annoyed that the request to take the survey has been made. Participants of complex surveys are often chosen by the survey provider and interrogated at inconvenient times. When a survey is conducted by telephone or face-to-face, the participant has just been interrupted from their previous activity. Accordingly, the participant's state of mind when answering the survey questions may not be positive and open. In addition, the participant may not have an opportunity to fully analyze the survey questions and produce an answer based on a complete understanding and analysis. While these survey participant conditions may be factored into the design of a complex survey, they detrimentally affect the survey results.

For simple surveys, as traditionally administered, there is often very little control over the selection of the possible survey participants. In some cases, the participant is invited by email, but even in those cases, only the email address of the participant is known. When the survey is taken, it is generally not known who is answering questions or how much time has been spent on the questions. Accordingly, the quality of answers to simple survey questions cannot be well known by the survey requestor. In addition, other problems exist. For example, it is difficult to establish a clear end time or duration for the survey while at the same time generating a sufficient number of participants.

### SUMMARY OF THE INVENTION

A computing server and a plurality of mobile devices communicate with each other as part of a survey system. The server can accept input from a survey requestor. Based on input, the system can communicate a survey request for data and a response to the request between the computing server and the mobile device. The system can also provide survey output data to the survey requestor.

According to one embodiment, a method to perform a survey includes accepting requestor input in response to a survey question generating web page. The requestor input is then stored in a repository. A survey is generated from information in the repository. A plurality of mobile devices receives an indication that the survey is available. The server accepts survey responses from a selected number of the plurality of mobile devices. Compensation is provided to each personal profile account of the mobile devices that participated in the survey.

According to one embodiment, a method to perform a survey with a wireless mobile device includes providing participant personal profile information to a computing server; receiving a survey from the computing server; accepting participant user input responses to questions in the survey; transmitting the participant user input responses to the computing survey; verifying compensation credited to an account associated with the mobile device from which input was received.

According to one embodiment, a computer-readable medium has contents that configure a computing platform to perform a survey to be sent to mobile devices and to compensate an account of those who participated. The computer platform provides the information related to the survey topics and questions to be asked on a survey to a requestor. The requestor provides information for a survey topic and to select questions to be asked. The computing platform generates the survey from the selected survey topic and the selected questions to be asked. The survey is communicated to selected computing devices. Survey responses from the computing devices are stored and organized. An account associated with the computing devices that responded is compensated after they respond.

### BRIEF DESCRIPTION OF THE DRAWINGS

The components in the drawings are not necessarily to scale relative to each other. Like reference numerals designate corresponding parts throughout the several views.

FIG. 1 is a system diagram embodiment for performing surveys.

FIG. 2 is a block diagram embodiment of a computer platform that a survey requestor or a survey host may use.

FIG. 3 is a block diagram embodiment of a mobile device.

FIGS. 4A-4F illustrate embodiments of interactive messaging that may be presented by a survey web-software application.

FIGS. 5A-5E illustrate additional embodiments of interactive messaging that may be presented by a survey web-software application.

FIG. 6 is a flowchart illustrating a process used by a computing server embodiment.

FIG. 7 is a flowchart illustrating a process used by a mobile device embodiment.

### DETAILED DESCRIPTION OF THE INVENTION

Particular embodiments of the system and method to perform surveys described herein have a web-server that enables survey requestors and survey hosts to simply and inexpensively design surveys. The surveys may be pushed out to predetermined survey participants that have chosen to receive surveys of selected subject matter. The survey participants may respond to the survey questions on any computing device including a mobile device.

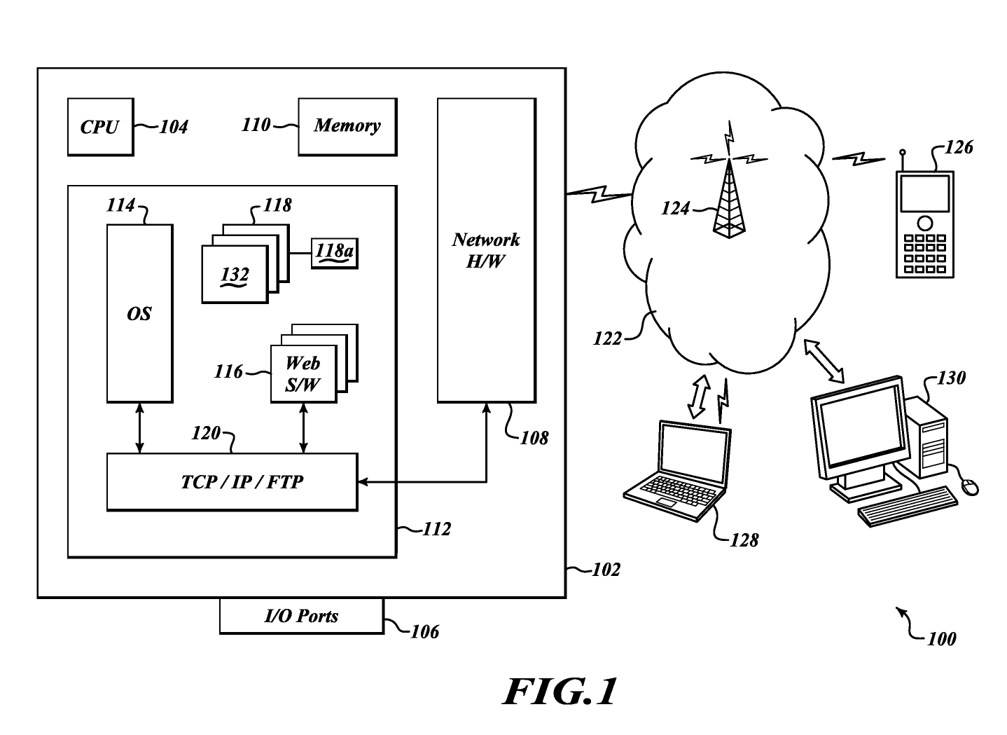

FIG. 1 is a system diagram embodiment for performing surveys according to one embodiment. In the survey system 100, a web server 102 is shown. Web server 102 has operative electronic circuitry including a central processing unit 104 (CPU), multiple input/output (I/O) ports 106, a high bandwidth network connectivity port 108, local memory 110, and system memory 112. Local memory 110 may include cache or any other embedded memory as well as external devices accessible by CPU 104. System memory 112 may include any single or combination of volatile and non-volatile computer-readable media for reading and writing.

Volatile computer-readable media includes, for example, random access memory (RAM). Non-volatile computer-readable media includes, for example, read only memory (ROM), magnetic media such as a hard-disk, an optical disk drive, a floppy diskette, a flash memory device, a CD-ROM, and/or the like. In some cases, a particular memory is separated virtually or physically into separate areas, such as a first memory, a second memory, a third memory, etc. In these cases, it is understood that the different divisions of memory may be in different devices or embodied in a single memory.

In a preferred embodiment of FIG. 1, within the memory 112, several software programs are resident including an operating system 114, a web server software application 116, a survey web-software application 118, a data repository 118a associated with the survey web-software application 118, and an intermediary networking software application 120.

The data repository 118a may be any type of data storage system that works cooperatively with survey web-software application 118 to support features of a website 132. For example, the data repository 118a may be a database, a series of hard-coded dynamic data structures, a set of linked lists, or any combination thereof. The data repository 118a may be embodied in a single device or may be distributed in multiple devices. In some cases, the data repository 118a is partially or wholly remote from the server 102 and accessible over a network.

The CPU 104 of the web server 102 retrieves and executes instructions from memories 110 and 112. The operating system 114 includes application and driver software that enables additional application software and system administrators to control the operation of server 102. For example, particular applications and drivers accept user input and provide system output through I/O ports 106. Keypads, computer mice, memory cards, serial ports, bio-sensor readers, touch screens, and the like may be coupled to the I/O port 106 to permit a system administrator or other web-server operator to provide control information into the web server 102. Displays, printers, memory cards, LED indicators, speakers, and the like are all useful to present information to the web-server operator.

In some cases, web server 102 is a single hardware machine having the hardware and software listed herein, and in other cases, web server 102 is a networked collection of hardware and software machines working together in a farm or cloud to execute the functions of performing surveys. Some of the conventional hardware and software of web server 102 is not shown in FIG. 1 for simplicity.

In addition to running application and driver software, the operating system 114 hosts a web server software application 116. In one embodiment, the web server software application 116 is a Microsoft Internet Information Services web server. The web server application hosts particular static and dynamic web page screen data that users of the Internet are capable of interactively viewing. The survey web-software application 118 described herein includes web pages hosted by the web server software application 116.

The intermediary networking software application 120 is a collection of one or more software programs that provide connectivity to computing resources outside of the web-server 102. For example, conventional transmission control protocol/Internet protocol (TCP/IP), file transfer protocol (FTP), user datagram protocol (UDP), and the like are useful to enable data such as web pages to be served to the outside computing resources, and further are useful to enable users of the outside computing resources to input data into the web server 102. That is, the operating system 114 and web server software application 116 are bi-directionally coupled to the intermediary networking software application 120 and the intermediary networking software application 120 is bi-directionally coupled to individual circuits of the high bandwidth network connectivity port 108. The bi-directional coupling enables the web server software application 116 to solicit a user for input information, accept the user information, and output survey data as screen data, screen updates, audio data or the like, commensurate with the user input information.

The high bandwidth network connectivity port 108 includes electronic networking circuits such as a Digital Signal 1 (T1), Digital Signal 3 (T3), fiber-optic, Ethernet, fax/modem, and other telecommunications circuits. The telecommunications circuits of the high bandwidth network connectivity port 108 provide the hardware layer interconnectivity of the web server 102, through a telecommunications network 122 to a wide range of outside computing resources.

The telecommunications network 122 includes a cellular communication network 124, conventional cable networks, satellite networks, fiber-optic networks, and the like. In a preferred embodiment, the telecommunications network 122 includes any communication hardware and software that cooperatively works to enable users of computing devices to view and interact with Internet web pages.

Resident in memory 112, the survey web-software application 118 embodies the software code of a survey design and administration website 132. Generally speaking, the website 132 accepts survey input information from a survey requestor and displays survey results to the survey requestor. The website 132 and the survey web-software application 118 work cooperatively to generate and administer surveys. The surveys are generated with input from the survey requestor and with survey expertise embedded in the survey web-software application 118. The results of the surveys are collected, analyzed, and consolidated with survey expertise embedded in the survey web-software application 118. As described herein, the survey expertise presented via the website 132 is useful to survey requestors and addresses the disadvantages of traditional complex and simple survey mechanisms.

FIG. 1 also shows other computing resources, including a mobile device 126, a laptop computer 128, and a conventional user computer 130. In a preferred embodiment, the computing devices 126-130 enable requestors and hosts to design, and various users to participate in, surveys. In some cases, information related to the surveys is communicated from and between the computing devices 126-130 via the telecommunications network 122. The survey data is also communicated from and between the computing devices 126-130 and the web server 102 where the information is processed. The processed survey data is communicated by web server 102 back to the survey requestor. In some cases, the web server 102 interactively presents the data to the survey requestor and others via the Internet.

User computers 130 comprise one or more computing devices operating separately or in a networked environment. In some cases, user computer 130 is a conventional personal computer operated by a single user. In other embodiments, user computers 130 are network computers processing data for other industrial, commercial, or business purposes.

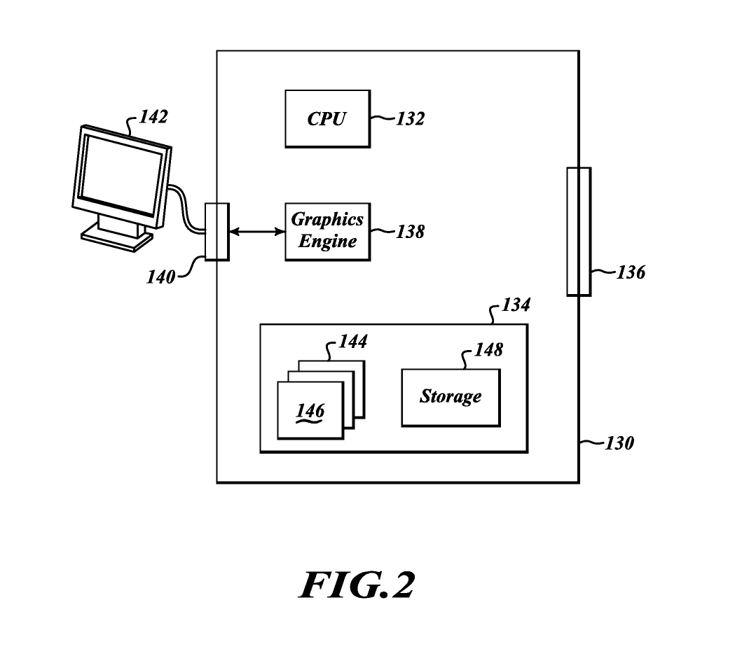

FIG. 2 is a block diagram of one embodiment of a user computer 130. One skilled in the art will recognize that the elements of user computer 130 are applicable to laptop computer 128 and other computing platforms. That is, embodiments of user computer 130, laptop computer 128, or other like computing devices may be configured as a system operable to execute methods to perform surveys.

User computer 130 has an architecture that includes operative hardware found in a conventional computing apparatus. For example, one or more central processing units (CPUs) 132, volatile and non-volatile memory 134, serial and parallel input/output (I/O) circuitry 136 compliant with various standards and protocols, wired and/or wireless networking circuitry are all components that may be found in the platform. A graphics engine 138 may supply or receive data through a graphics port 140. The graphics engine 138 and graphics port 140 may optionally be present and configured to accept input or provide output to a display 142.

As known by one skilled in the art, the computing platform 130 has one or more memories 134, and each memory comprises any combination of volatile and non-volatile computer-readable media for reading and writing. Volatile computer-readable media includes, for example, random access memory (RAM). Non-volatile computer-readable media includes, for example, read only memory (ROM), magnetic media such as a hard-disk, an optical disk drive, a floppy diskette, a flash memory device, a CD-ROM, and/or the like. In some cases, a particular memory is separated virtually or physically into separate areas, such as a first memory, a second memory, a third memory, etc. In these cases, it is understood that the different divisions of memory may be in different devices or embodied in a single memory.

Memory 134 comprises executable software instructions 144 and storage space 148. The storage space may include a file system, dynamically created data structures, a stack structure, local storage space, and the like. The executable software instructions 144 are also called system software 144.

The system software 144 is found in a conventional computing platform and includes an operating system, software drivers to direct operations through the I/O circuitry, networking circuitry, and other peripheral component circuitry. In addition, system software 144 also includes operative application software such as network software for communicating with other computing devices, database software for building and maintaining databases, and task management software for distributing the communication and/or operational workload amongst various CPU's.

In many cases, the methods for conducting surveys described herein are delivered with a conventional Internet web browser. In other cases, software 144 has a survey software application 146 to conduct surveys. In such cases, the optional survey software application 146 particularly configures the computing platform 130 to execute methods to perform surveys as described herein.

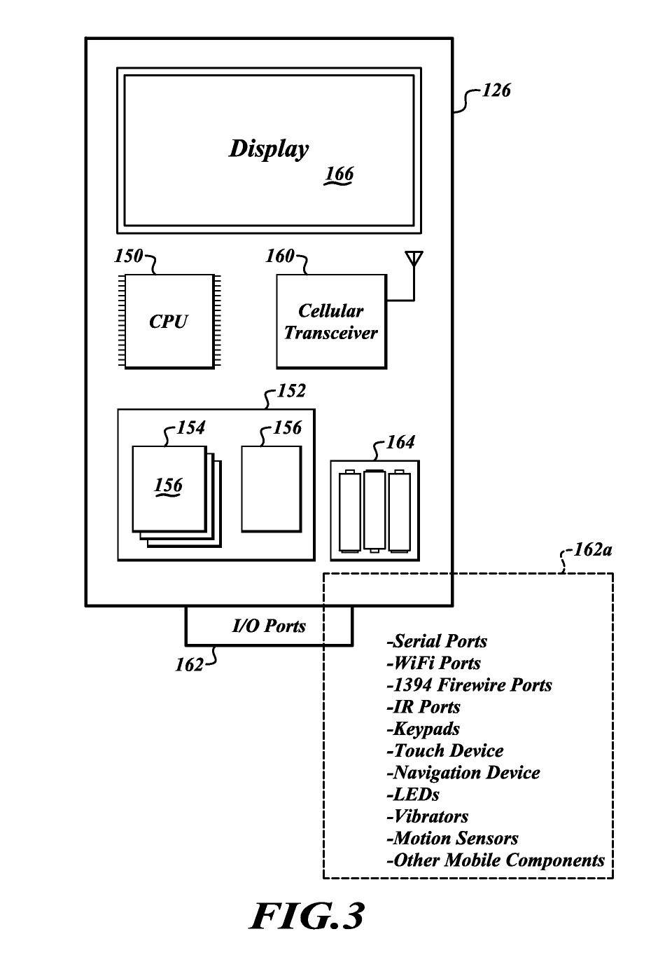

FIG. 3 is a block diagram embodiment of a mobile device 126. The representative illustration of FIG. 3 is one non-limiting example of the type of mobile wireless device useful for implementing a system and method to perform surveys. Many other mobile devices, including personal media players (PMP's), personal digital assistants (PDA's), handheld personal computers (HPC's), global position system (GPS's), gaming devices, and the like can also be configured as described herein to implement a system and method to perform surveys. In fact, virtually any mobile computing device with a compatible transceiver and proper configuration can be a mobile device 126.

The mobile device 126 is an electronic communication device having one or more central processing units 150 and a volatile and/or non-volatile memory 152. The memory 152 stores instructions and data acted on by CPU 150.

Memory 152 comprises any combination of volatile and non-volatile computer-readable media for reading and writing. Volatile computer-readable media includes, for example, random access memory (RAM). Non-volatile computer-readable media includes, for example, read only memory (ROM), magnetic media such as a hard-disk, an optical disk drive, a floppy diskette, a flash memory device, a CD-ROM, and/or the like.

Inside memory 152, a particular collection of software instructions 154 may be executed by CPU 150. The software instructions 154 typically include an operating system, conventional software applications, device drivers, and the like. The software instructions 154 may also include a particular mobile device survey application 156. The survey application 156 is useful to perform the methods of conducting surveys described herein. In other cases, a conventional Internet web browser for mobile devices, which is part of software instructions 154, is used to perform the methods of conducting surveys.

A transceiver 160 may be used to communicate with a web server 102. That is, survey questions may be communicated from the web server to the mobile device 126 via the transceiver 160, and survey results may be communicated from the mobile device 126 via the transceiver 160.

The results of the surveys may be stored in data storage area 158 of memory 152. The data storage area 158 may include a file system, database, stack space, local variables, or other data structures. Some or all of the survey results are communicated from the mobile device 126 via the transceiver 160.

The mobile device 126 may further have a collection of input/output ports 162. The I/O ports 162 are useful for coupling hardware or software peripheral devices 162a to the mobile device 126. There may be one or more optional hardware or software peripheral devices 162a coupled to the mobile device 126 via the I/O ports 162.

In some embodiments, the optional peripheral devices 162a may be used for passing data over short distances to and from the mobile device 126. For example, serial ports, USB ports, WiFi ports, Bluetooth ports, IEEE 1394 FireWire, and the like can communicatively couple the mobile device 126 to other computing apparatuses. Additionally, the I/O ports 162 can be used to couple other optional peripheral devices 162a such as keypads, touch screens, navigation dials, light emitting diodes (LEDs) or other illumination outputs, audio devices, vibrating devices, motion sensors or other motion detection devices, and other mobile device components to the internal hardware and software of the mobile device 126.

Mobile device 126 has a battery 164 and a display 166. The display 166 is used to communicate survey information to a user of the mobile device 126.

The cellular transceiver 160 is used to couple the mobile device 126 to other communication devices through the cellular communication network 122. In some cases, software 154 and data in storage area 158 are communicated between the mobile device 126 a web server 102 via the cellular transceiver 160. That is, bidirectional communication between a mobile device 126 and a web server 102 is facilitated by the cellular transceiver 160.

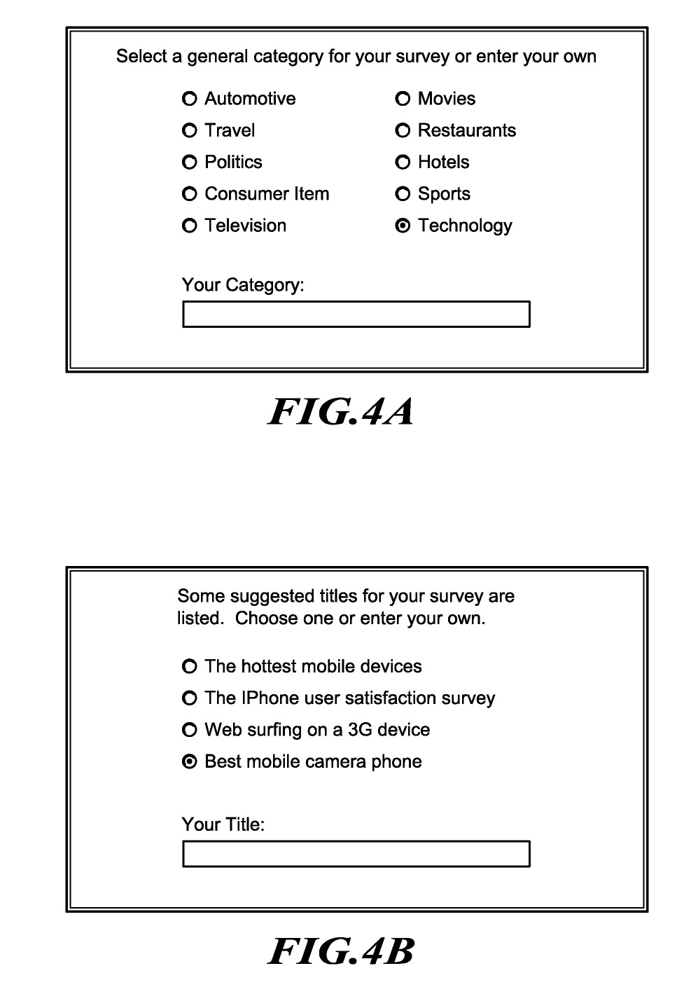

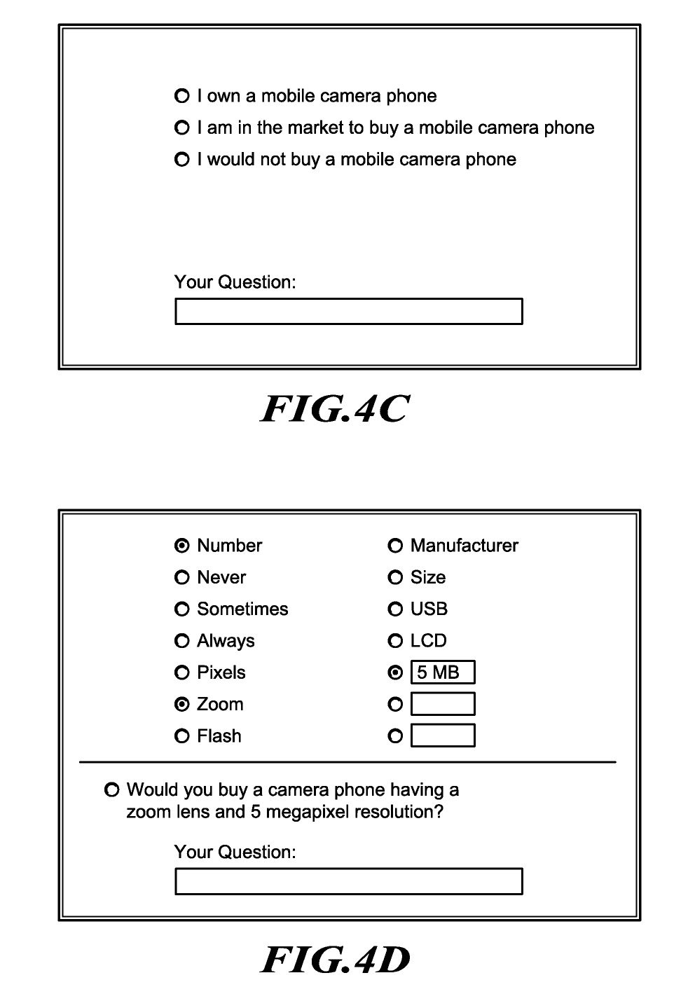

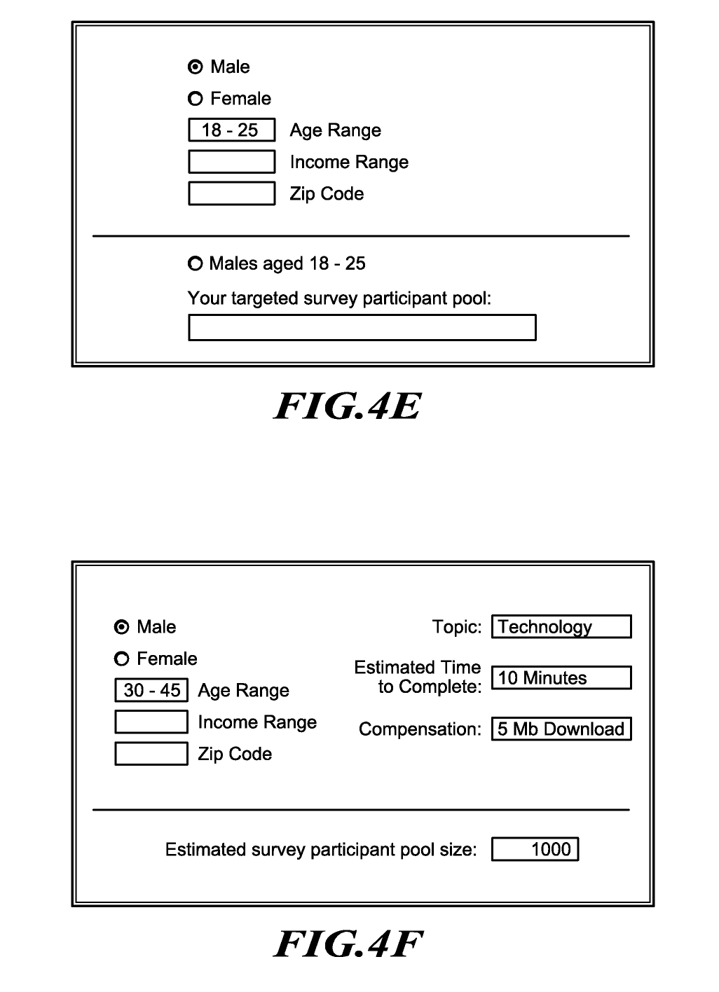

FIGS. 4A-4F illustrate various embodiments of interactive messaging that may be presented by survey web-software application 118 on the survey design and administration website 132. The embodiments shown in FIGS. 4A-4F are non-limiting.

FIGS. 4A-4F represent some of the ways a survey may be created by a requestor. The survey requestor as used herein includes anyone in the group who is part of the creation of a specific survey and includes authors, originators, designers, and any others in the group that provide input for the origination of a specific survey to be sent to participants. A single survey may have more than one person as part of the origination team, whether designer or author, all of whom are jointly referred to as a requestor.

There are many different ways that information can be presented to survey requestors and many ways that requestor input can be accepted. In a preferred embodiment, website 132 has many “wizards” or helpful software applets of the type shown in FIGS. 4A-4F that guide a survey requestor with as much or as little detail as the survey requestor desires. That is, survey web-software application 118 has software that represents the expertise of a large group of highly skilled survey designers who are capable of designing complex surveys. Survey web-software application 118 is able to access its large repository of data 118a in order to generate many web pages of helpful suggestions to a survey requestor. During interactive use of website 132, the survey requestor can spend a great deal of time or very little time to design a survey.

Another advantageous feature of the survey web-software application 118 is that the repository of information 118a used to generate the surveys can continue to grow. For example, the repository 118a can be organized as one or more highly indexed databases of survey topics, questions, answers, titles, and the like. The repository 118a can be organized as a relational database, an operational database, a hierarchical database, or any other organization to assist in the creation of surveys. As time passes, information in the repository 118a can be added, modified, or otherwise changed e.g., based on information that is input via website 132, additional information created by the administrator of website 132, or by some other means. In some cases, the information in the repository 118a can be updated at the time the survey is requested and after survey responses are received from survey participants. Accordingly, information taken at the time the survey is created and at the time the survey is conducted may be used to prioritize, categorize, or otherwise value the particular information stored in the repository 118a.

The entries in the repository 118a can be either whole entries or fields of individual entries, for example the entries shown in the output of FIGS. 4A-4F. The database entries can be relationally related or indexed in some other way. As the survey requestor continues to answer questions or proceed with the help of particular wizards, the information in the repository 118a can be utilized in many ways or not used at all. Accordingly, the survey requestor may obtain the advantages of a highly skilled survey designer or may build their own simple survey with very little help.

In the system and method to perform surveys described herein, the user of the interactive website 132 chooses a particular purpose of the survey with the help of the web-application software 118. As illustrated in FIG. 4A, a series of optional choices may be presented to the requestor. Alternatively, the requestor may enter a custom choice.

FIG. 4A further illustrates that the web page accepts a requestor's entry for a particular purpose of a survey. Upon choosing one of the categories presented on website 132, additional levels of choices may be used to guide the survey requestor to a particular purpose for the survey. Similarly, if the user enters a choice in a text entry box for example, then survey web-software application 118 may try to match the entry to one or more particular entries in its repository 118a or the application 118 may simply add the choice to its repository 118a.

The particular purpose of the survey is generally used as an overriding guide by a survey host to design the survey. In most, but not all surveys, the title of the survey, along with the questions and a range of acceptable answers, is designed and offered by a survey host. In other cases, the particular title, questions, and answers are designed by the survey requestor. In still other cases, some combination of other parties collaborates to design the survey details.

A survey host is the person or source of a framework for the possible creation of many different surveys. A survey host is generally different than a survey requestor, which is a party or person who creates a specific survey. For example, a survey host may provide the computer hardware, software, and networking platform. The survey host may also provide a large bank of sample survey questions that many different requestors may use in the creation of various specific surveys.

After answering a complex or a simple set of questions, the survey web-software application 118 may present a series of suggested survey titles to the survey requestor. FIG. 4B illustrates one embodiment of survey titles based on input information supplied by a survey requestor.

In some cases, the title of a survey is important because it often provides the first indication to a potential survey participant as to the survey's content. That is, a survey title often provides a summary of the purpose of the survey and the types of questions that will be asked. To a participant, taking a survey represents an investment in time and thought. A well drafted survey title, which sparks the interest of the potential survey taker, is one way to increase the likelihood that a potential survey participant will invest the time to take the survey. Accordingly, as illustrated in FIG. 4B, a survey requestor has the advantage of both a complex survey design and a simple survey design. The survey requestor can have the benefit of a complex survey design by accepting substantial help from survey web-software application 118 to prepare a survey title or alternatively, the survey requestor can simply enter a desired survey title as can be done in a simple survey design.

Drafting high quality survey questions generally takes very deliberative effort, a well-tested and methodical approach, or some combination of both. A high quality survey question is one that provides an honest, clear, concise, and unambiguous datum for the survey requestor.

High quality survey questions often have particular characteristics. For example, questions should be clear, but not too long. It has been observed that long questions are more difficult to follow and participants often tend to give such questions less thought than the survey designer intended. Questions should be focused on the information sought to be received or conveyed by the survey requestor. When questions are not well focused, then surveys tend to take longer, have more questions than desirable, and may produce low-quality responses.

In some surveys, questions are not presented in a rigid, inflexible sequence. Instead, some surveys are generated so as to permit dynamic question presentation. In some embodiments, the survey engine could allow for multiple different follow-up questions to some or all of the questions within the survey. For example, dynamic questions typically are followed by questions with language required to clarify a response based on several possible responses to a previous question. By altering some or all of the remaining questions in a survey, or by altering the question presentation order based on previous input, questions can be simplified for the participant while valuable data is collected for the survey requestor.

Questions for surveys should also be drafted using language that allows a potential survey participant to feel comfortable. Choices regarding language include the choice of national language, the local dialect, accepted and known terminology or jargon, and the like.

With respect to high quality survey questions, many other factors are also often considered. For example, most survey questions are limited to a single question. As contrasted with a compound question, a single question tends to reduce ambiguity and tends to reduce the likelihood that a survey participant can honestly answer the question. That is, a compound question may present a survey participant with a dilemma wherein the survey participant agrees with a first choice in the question but disagrees with a second choice in the same question. In such cases, even when the survey participant provides an answer, the results will often be of questionable quality.

Also with respect to high quality survey questions, another factor that may be considered is how questions are grouped. For example, questions that are related with respect to subject matter may be grouped sequentially or at least near each other. As another example, questions having numerical answers, one word answers, emotional answers, multi-part answers, or any other common characteristics may be grouped together.

FIG. 4C illustrates one embodiment of a wizard that helps a survey requestor design a survey question. Several complete questions are presented that may be selected, or a user may enter their own question. In the embodiment of FIG. 4C, many web pages can be presented on website 132 with choices for many potential questions. The questions may be retrieved from entries in the repository 118a of survey web-software application 118. Alternatively, or in addition, they may be constructed from information previously entered by the user during the creation of the survey.

FIG. 4D illustrates another embodiment of a wizard that helps a survey requestor design a survey question. As shown in FIG. 4D, a variety of keywords and other entries are available to a survey requestor to choose that are related to a particular topic. In the embodiment of FIG. 4D, as a requestor enters information, sample questions are dynamically created. If a requestor likes a question that is created, then the requestor can accept the question, modify the question, or choose different arrangements of keywords and other entries so that a new question is generated.

During the process of survey question generation, the survey web-software application 118 may continue to draw information from its data repository 118a, modify the information in the data repository 118a, or add information to the data repository 118a. In addition, as survey participants respond to survey questions, the frequency of response, types of response, speed in entering a response, and many other aspects can be used to rate the information used to generate the question. Subsequently, survey web-software application 118 can adapt its mechanisms of information presentation to future survey requestors.

As shown in FIG. 4E, in addition to generating questions for a survey, a survey requestor can identify a group of targeted survey participants. In many cases, the group of targeted survey participants has one or more particular characteristics in common. For example, in a survey commissioned by a business owner, a targeted group of survey participants would be those that the business owner, along with the help of the survey host, determines to be likely customers of the business. The likely customers may be chosen by gender, age, household income, geographic location, hobbies, or any other single or composition of characteristics. In another example, a politician may commission a survey to poll likely voters, constituents, political party members, or the like.

In other cases, a cross-section of a particular group may be selected for participation in the survey. For example, a survey requestor may understand that her business customers tend to be predominantly female. Accordingly, the business owner may limit survey participation to only females, but the group of females may include those having a range of ages, household income, number of children in the house, and the like. In some surveys, having such a cross-section provides desirable survey results to the survey requestor.

In other surveys, a broad range of survey participants may be permitted to take the survey, and questions in the survey will direct the survey participant to self-identify into one or more particular groups. Accordingly, the analysis of survey question responses may enable the survey host or survey requestor to classify all of the response from each particular survey participant. For example, a response to a question requesting the participant's age, gender, familial status, or level of school attended will provide useful data that can be used to group responses from several survey participants together.

FIG. 4E illustrates one embodiment of a wizard that helps a survey requestor choose a targeted group of survey participants. There are many ways of targeting a survey to a particular group and FIG. 4E illustrates only one non-limiting way. In FIG. 4E, the survey requestor is presented with a series of interactive questions and choices to narrow or broaden the potential survey participant pool. Just as in many areas of website 132, in some cases, the identification of the potential survey participant pool is chosen on one web page, and in other cases, the identification is made over many web pages.

In some cases, when the survey requestor is designing the survey, the survey web-software application 118 may inform the survey requestor of how many potential survey participants are in the targeted group. For example, when a group of potential survey participants have previously “opted in” or otherwise indicated a willingness to take surveys on the topic of the survey, then survey web-software application 118 can inform the survey requestor how large the pool is.

FIG. 4F illustrates a web page that dynamically indicates to the survey requestor how many potential participants have currently agreed to accept surveys on the particular survey subject. For example, as shown in FIG. 4F, several details about the survey are presented, and based on the details, the particular survey participant pool size is reasonably large. In the example of FIG. 4F, the potential survey participant pool includes men, ages 30-45, that have registered, e.g., opted in, to take surveys related to technology, surveys that are estimated to take ten minutes or less to complete, and surveys that provide one song download as compensation to the survey participant for taking the time to complete the survey.

Many other aspects of generating a survey, choosing a survey participant pool, compensating participants for completing a survey, and the like are also administered by the survey web-software application 118. These other aspects, while not expressly illustrated in name, are illustrated in principle in FIGS. 4A-4F.

For example, in addition to drafting survey questions, many surveys provide a range of responses for each question. The survey web-software application 118 is configured to present a complex and simple set of wizards or other functions that help draft survey answers. In addition to the range of answers to one or more survey questions, the survey requestor may further design the type of answers that are presented to a survey participant. That is, in some cases, survey questions may be answered by radio buttons, check boxes or multiple check boxes, fill in the blanks, grouped responses, e.g., Age=below 18; 18-25; 26-55; . . . , and the like.

In some cases, survey answers may provide wide open space for a survey participant to make comments or expand thoughts. Such survey answers may increase satisfaction derived by the survey participant from taking the survey, may provide valuable input to the survey requestor, and many other advantages. In such cases, the survey web-software application 118 may further analyze the length of the answers, keywords in the answers, or other aspects of the answers to further supplement its information repository 118a.

In still other cases, survey answers may be in many different forms. For example, some survey answers may include selecting from a group of images, selecting from multiple audio clips, selecting from multiple video clips, responding with a participant provided image, audio, or another file (e.g., the survey participant could speak a response to a question, or be asked to take and submit a picture). Other survey answers may be in any other type of format as well.

Another advantageous feature of the survey web-software application 118 may provide compensation to survey participants for the successful completion of a survey. The type of compensation offered can take many forms. In some cases, the compensation may be one or more song, book, or video downloads, one or more software program downloads, access to particular content on another website, or many other things. In other cases, the compensation may be added cell phone time, payment of part of the phone bill for the cell phone that made the call, or other cash-related type compensation. Alternatively, the compensation may be the publicity generated from the survey results. Alternatively still, the compensation may be product offerings from the survey requestor.

The compensation may be delivered to the survey participant in many ways. For example, compensation can be delivered via a secure Internet-based transaction, via crediting an account stored on a computing device such as web server 102, via triggering a purchase and delivery from a third party, or via other like methods.

In a preferred embodiment, website 132 will present the survey requestor with a range of compensation choice offerings based on particular business agreements that the website host or representative has previously arranged. For example, if the website 132 has previously arranged a particular business relationship with a music provider, then the survey web-software application 118 can enable the survey requestor to offer particular music downloads to survey participants. In this case, when the music is downloaded or by some other arrangement, the music provider is paid. The payment to the music provider in this example may come directly from the survey requestor or may come from the website host who is otherwise paid by the survey requestor.

It is clear from the embodiment described above that many business relationships and compensation arrangements can be formed. In some cases, different compensation alternatives are offered to different survey requestors, for example based on their frequency of survey generation. Often, the particular relationship and compensation arrangements are incorporated into the repository 118a of the survey web-software application 118.

In another preferred embodiment, the survey requestor may be permitted to enter his own compensation offering. In some cases, this offering is stored in the repository 118a of the survey web-software application 118 and in other cases it is not. In some cases, the survey requestor compensation offering is made available to other survey requestors. For example, if a particular band offers a download of its music as compensation for a survey about its music, the band may enable its compensation offering to be used by other survey requestors. In one alternative of this example, if a radio station subsequently conducts a survey of a targeted listening audience, the band may enable the radio station to use the download of the band's music as compensation for the radio station's survey.

Another advantageous feature that may be implemented in the survey web-software application 118 for presentation on website 132 is grammatical and other administrative help for survey creation. For example, spell-checking, grammar support, identification of compound questions or other rating of question comprehensibility, grammar localization for particular geographic regions, grammar structure for particular educational level, question groupings by subject matter, question type, or other characteristic, number of hours or days that the survey will be active i.e., time to live, and the like.

Still another advantageous feature that may be implemented in the survey web-software application 118 for presentation on website 132 is multiple language support. In some cases, the web-software application 118 is capable of translating the information entered by a survey participant and generating surveys in one or more languages different than the language presented when information is collected. In some cases, the surveys are created in multiple languages when they are generated, and in other cases, the survey questions and other information is translated when the survey is delivered to a potential survey participant.

Another aspect of survey web-software application 118 is the analysis and dissemination of survey results. Typically, the survey results are made available to the survey requestor, but in some cases, other parties may be given access to the results. In some cases, the survey requestor expressly identifies the other parties that may have survey results access, and in other cases, the website 132 host identifies which parties may have access. In some cases, the accumulated or other composite results of surveys are made available to the survey requestors.

Survey web-software application 118 may also compile the results of completed surveys. In some cases, raw data is made available, and in other cases, composite data is made available. The composite data may indicate the number of survey participants that provided particular survey question answers, the number of survey participants that failed to answer survey questions, the average time to complete question, and many other statistical analysis results.

Still another set of features of survey web-software application 118 are related to the survey participants. Information may be interactively presented on website 132 that is targeted toward actual and potential survey participants.

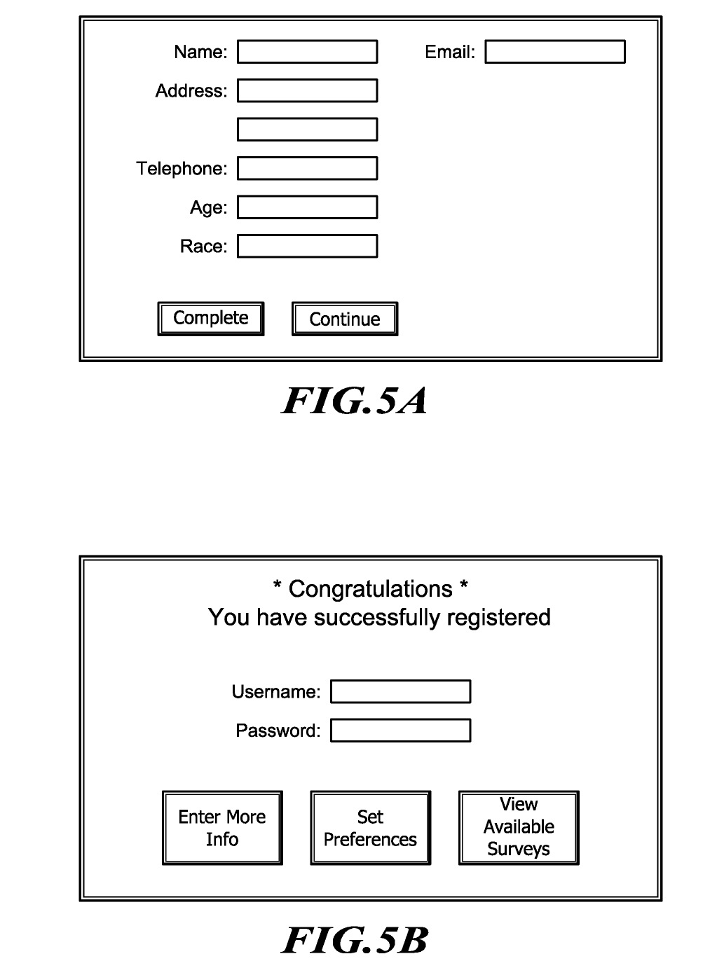

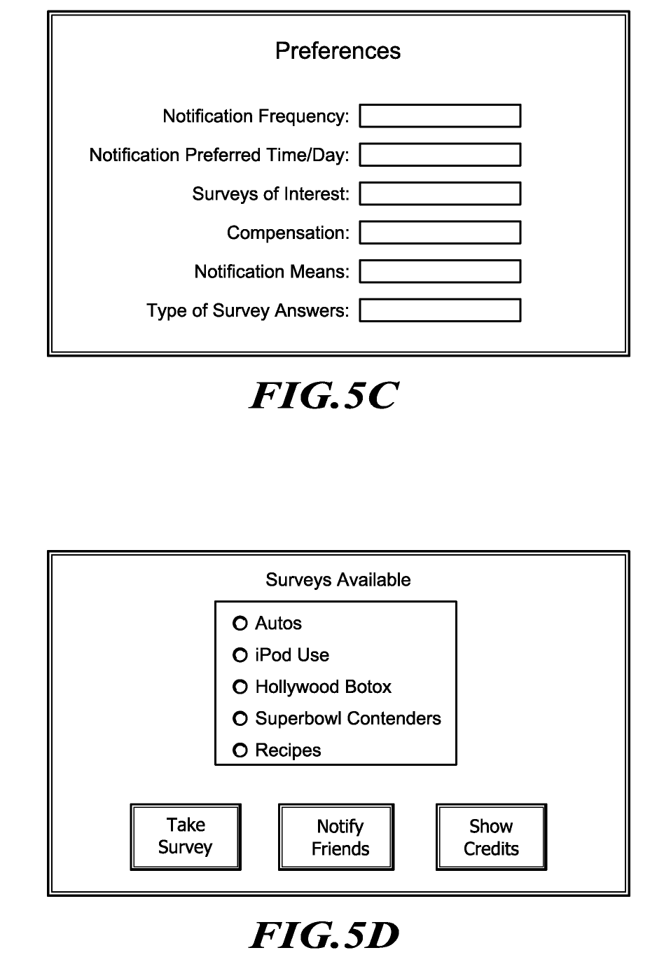

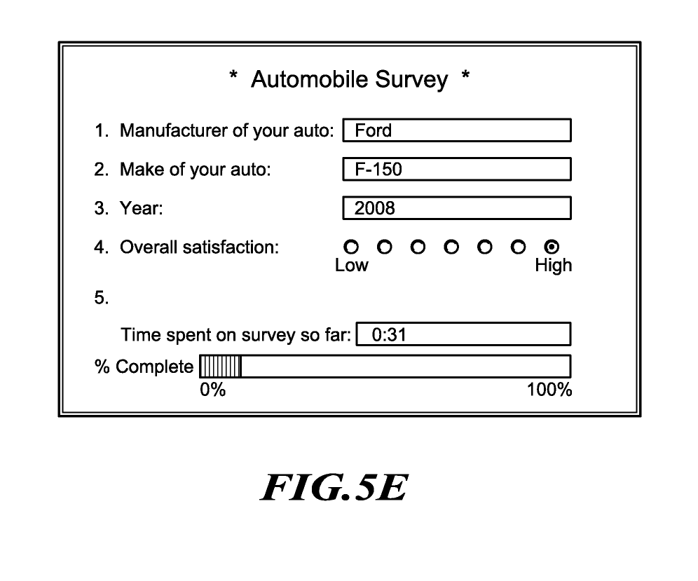

FIGS. 5A-5E illustrate various embodiments of interactive messaging that may be presented by survey web-software application 118 on the survey design and administration website 132. The embodiments shown in FIGS. 5A-5E are non-limiting. There are many different ways that information can be presented to users and many ways that user input can be accepted.

FIGS. 5A-5E illustrate web pages displayed on computing devices such as mobile phone screens. The web pages are directed toward survey participants and potential survey participants. The website may be accessed via a mobile phone, computer, or alternatively, the survey screen for the participant may be provided on a cell phone format page that is not coupled to the Internet. In some embodiments of the system and method to perform surveys described herein, potential survey participants must register with the website 132 host provider or other representative in order to participate in surveys. In other cases, no registration is needed in order to take surveys, but registration is needed in order to receive compensation for taking surveys. In still other cases registration is needed in order to receive surveys on a mobile device 126, to have access to feature-enhanced areas of website 132, to receive notifications of new surveys available, or to receive other benefits.

To register with website 132 or other representative of website 132, the potential survey participant typically provides information via website 132. The information is processed by the survey web-software application 118 and some or all of the information is stored in the data repository 118a. The information may include personal identification information such as name, address, telephone number, and the like. The information may also include categorical information such as age, race, zip code, profession, years of schooling, political affiliation, and the like. The information may also include other personal information such as epidemiological characteristics, personal habits, personal preferences, and many other things.

FIG. 5A illustrates a registration page embodiment of website 132. In the embodiment, a potential survey participant is encouraged to provide a range of information that may be used by the survey web-software application 118 during survey generation. For example, the information may be used to generate the pool of potential survey participants for a requestor. In some cases, a potential survey participant registration page of website 132 operates to fill in data of a comprehensive survey participant profile. The survey participant profile, also called a personal profile, is stored in the data repository 118a. The personal profile may be filled in quickly, gradually, or over a long time of many different sessions when the potential participant enters information from several website 132 pages.

In some cases, it may be desirable to minimize the burden of the initial data gathering process which is required to generate a new potential survey participant personal profile. One way of minimizing the burden involves asking a predetermined number of questions sufficient to match the participant with an existing survey. The questions may each have one or more answers capable of matching the new potential participant with their first survey. Subsequently, the new potential survey participant will have answered enough questions to match them with a survey.

In addition, when the survey participant answers questions, some of the answers could be added to the participant's profile. In some embodiments, additional questions, which are not part of the survey requestor's questions, could be added to the survey. The added questions could be used for the purpose of further developing the personal profile for a specific survey participant.

Another benefit of building dynamic personal profiles for survey participants is to provide ongoing quality assurance. For example, one problem that arises in some surveys is the inability to identify participants who may be answering untruthfully. By building dynamic personal profiles, that encompass answers to previous surveys, it may be possible to identify participants that provide unreliable answers. That is, a comparison of answers to identical questions from multiple surveys may be used to establish a reliability rating for reach survey participant. Survey participants that fall outside of acceptable reliability criteria could be removed from eligibility for some or all of the surveys that might otherwise be available to them.

A database of dynamic personal profiles for potential survey participants may be desirable to survey requestors. That is, it may be desirable for survey requestors to have some measure of the reliability of the participants in a specific survey. In some embodiments, the results provided to a specific survey requestor for a specific survey may include answers from a specific survey participant. The results provided may also include other answers from the same participant, which were previously given when asked the same question in a different survey. In such embodiment, the survey requester may not be given access or information about the other survey, but the survey requester could be alerted that there is some degree of uncertainty to the response from a particular survey participant for a specific question. Alternatively, or in addition, after a survey participant provides consistent and reliable answers to certain questions, the questions may be omitted from future surveys provided to the respective survey participant.

FIG. 5B is a confirmation page embodiment of website 132. A web page as shown in FIG. 5B is typically served when a potential survey participant has entered at least a minimum amount of information. Once a potential survey participant has entered at least a minimum amount of information, the potential participant may access other web pages of website 132. For example, the potential participant may enter additional profile information, may set personal preferences, or may view surveys that may be taken. Often the profile information that the potential survey participant enters is used by the survey web-software application 118 to qualify the potential participant for particular surveys.

FIG. 5C is a potential survey participant preference page embodiment. Many types of preference information can be entered via one or more preference web pages of website 132. In addition, the information can be entered in many different ways. For example, drop down boxes, radio buttons, text boxes, and many other mechanisms can be used to enter information.

In many cases, people enjoy taking surveys as a way of having their personal tastes, biases, preferences, prejudices, and other opinions accounted for and considered by businesses, policy makers, and others. On the other hand, many people are annoyed when a request to take a survey is received at an inconvenient time or place. The survey web-software application 118 provides an advantage to survey participants to offer surveys at convenient days, times, and places selected by the survey participant.

As shown in the web page embodiment of FIGS. 5A-5C, a potential survey participant can enter personal information that includes survey offering choices. For example, one survey participant may choose to be notified of survey offerings on a particular calendar day and another participant may choose a particular day of the week. A survey participant may choose a particular hour to be notified and another participant may choose mornings, afternoons, or evenings. In some cases, multiple or overlapping categories can be selected.

In some embodiments, the preferences entered by the potential survey participant are used to determine which surveys may be available to the potential participant. In some cases, available surveys may be pushed to the potential survey participant according to the schedules and other indications of survey notification preferences entered. In other cases, simple indications that surveys are available may be provided to the user participant either automatically or when the potential survey participant requests such indications.

Also illustrated in FIGS. 5A-5C, potential survey participants may choose topics for surveys in which they are interested. In some cases, the choices may be for common topics. In other cases, the choices may be only for topics that have active surveys available. In still other cases, the user may be able to enter their own topics by typing in a text box or by some other means.

One particular advantage of some embodiments of the system and method to perform surveys described herein is that a potential survey taker's topical preferences can be stored in the data repository 118a. Accordingly, the topics become available to survey requestors. That is, during the course of designing a survey, a survey requestor may be presented with information on website 132 that includes a topic entered by a potential survey participant. In this way, particular language or terms that are socially contagious can quickly and seamlessly be adapted into the survey system. Language and terms that are socially contagious, e.g., viral, are include those that quickly spread through social groups to become the language or terms of choice of the social group.

Another embodiment shown in FIG. 5C is that a potential survey participant may enter one or more types of compensation that the potential participant prefers in return for taking surveys. It is recognized that when a survey participant takes a survey, the participant is providing information to the survey requestor and others that was not previously known. The information may be of little value or of great value, but in any case, the information typically has at least some value. In return for the value provided to the survey requestor, some embodiments of the system and method to perform surveys described herein enable the survey requestor to compensate the survey taker for the information provided or otherwise reimburse the survey taker for the time they took to provide survey answers.

The compensation preferences of a potential survey participant may include one or more choices and the choices may be entered by any known means. For example, drop down boxes, separate browser windows, text entry boxes, and the like are all mechanisms that enable a potential survey participant to enter preferences.

In some embodiments, the potential survey participant can enter a preferred type of compensation that is not currently stored in the data repository 118a. In this case, the survey web-software application 118 will store the new preference in the data repository 118a. Subsequently, survey requestors may choose to offer as compensation the same thing that was entered as a preference by the potential survey participant.

Permitting a potential survey participant to enter his own choice of preferred compensation provides many advantages. For example, some people in particular social groups may all find value in the same thing. This thing that is valued may be disproportionately valued within the social group. For example, a particular type of song or a song by a particular band may be highly coveted by members of the particular social group. In these circumstances, the identification of a particular pool of survey participants can be easy to identify. In addition, the quality of survey responses can also increase.

Another advantage of permitting a potential survey participant to enter his own choice of preferred compensation is that the system and method to perform surveys described herein can be very quick to adapt to changing society. That is, it is recognized that some social fads and practices can be both very fast spreading, very intense and very short lived. By permitting the potential survey participants to choose a preferred compensation, the survey web-software application 118 can be dynamically and automatically updated to improve the results that survey requestors can achieve.

Another embodiment shown in FIG. 5C enables a potential survey participant to enter one or more means of notification that surveys are available to the potential survey participant. In some cases, a potential survey participant may choose to receive an email message, a text message, a telephone call, or some other direct and immediate contact. In other cases, an alert is calendared on a mobile device 126 accessible calendar for the potential survey participant. In still other cases, the potential survey participant may access website 132 to learn about available surveys.

Another embodiment shown in FIG. 5C enables potential survey participants to only view and participate in surveys of particular types. For example, some potential survey participants may desire surveys that have answer choices embedded and others may desire surveys that enable the free form entry of a survey participant's thoughts or words. Some potential survey participants may desire surveys with a particular maximum number of questions and others may desire surveys with a particular maximum estimated time to complete. Many other particular types of survey preferences are possible and the choices are nearly unlimited. As with embodiments of each of the survey preferences, a user may be permitted to enter their own choices instead of merely selecting from predetermined lists. Accordingly, the survey web-software application 118 may make the choices available to survey requestors so that new trends can quickly, seamlessly, and dynamically integrated into the system and method to perform surveys described herein.

FIG. 5D illustrates another web page that provides information to survey participants. One embodiment of FIG. 5D has a survey queue that informs a survey participant of available surveys that meet the participant's profile criteria. The participant in this embodiment may choose to take one or more surveys, reject one or more surveys, or hold one or more surveys on the queue. For example, survey topics such “autos,” “iPod use,” or the like may be displayed.

In some cases, more information about the survey may be made available to the survey participant. For example, information such as when the survey became available, how many questions, how many others have already taken the survey, what compensation is offered, and other like information may be available.

Also shown in FIG. 5D, a survey participant may take several other actions according to his survey participant profile. For example, a survey participant may communicate information about one or more surveys to others. Such social networking integration can provide advantages to the survey requestor. For example, a survey pool of potential participants can increase, the time to reach a minimum preselected number of responses for the survey may be reduced, the quality of survey responses may be increased, and the potential pool of survey participants may be more narrowly defined.

FIG. 5E illustrates one embodiment of a survey. The survey in the example is related to automobiles, and several questions are shown. In some cases, the questions may have preselectable answers, and in other cases, the survey participant may create his or her own answer. In some cases, other information may be collected from the survey, and the information may be displayed to the survey participant. For example, FIG. 5E informs the survey participant how much time the participant has spent on the survey, but additional metadata information may also be collected such as how much time the participant spent on each question, whether the participant has changed any answers, previously selected answers before changes, and the like. Also shown in FIG. 5E, an indication of how much of the survey has been completed relative to the total length of the survey is provided to the survey participant. The indication can be a ratio, a time estimate, an audio or other sensory indication, or some other mechanism.

The survey of FIG. 5E may be delivered in many ways. For example, the survey may be displayed on the computing device 122, 126, 130 in a host application such as a web browser or may be directly executed as a standalone application. The survey may be presented audibly and spoken results may be received from the survey participant. In addition, the survey may take advantage of other peripheral software or hardware on the computing device to ask survey questions and receive survey answers.

In one example, when a survey is delivered to a mobile device 126, light emitting diodes, vibrators, motion sensors and other peripherals may be used to ask questions and receive answers.

Another aspect of some embodiments of the system and method to perform surveys described herein enables a survey participant to view and spend compensation already earned. In some cases, the compensation is accumulated into a single value, and in other cases, the compensation remains individually identifiable. In some cases, more information about the compensation is available to the survey participant, for example, when the compensation was earned, how long it is available, whether it may be transferrable, and other things. In some cases, statistical compensation information related to the survey participant or to other survey participants may also be available.

Many of the features related to potential survey participants and actual survey participants have been described herein as emanating from the survey web-software application 118 and presented on website 132. Typically, the features are available to a wide range of computing devices 126-130 via communication network 122 and an Internet browser operating on the computing device 126-130. In some cases, however, the features are available on a mobile device implemented in another way.

For example, a mobile device 126 may implement many of the features described in relation to FIGS. 5A-5E with a particular mobile device survey application 156. In such cases, the cellular transceiver 160 of the mobile device 126 is communicatively coupled to the computing server 102. The mobile device survey application 156 is able to cooperatively send and receive data from the survey web-software application 118.

In some embodiments, all of the survey participant profile information and other information that particularly identifies a potential survey participant is resident in memory 152 of the mobile device 126. Such configurations enable a potential survey participant to have an increased level of privacy. In these cases, encryption, unique user ID's, and other techniques or systems can be used to facilitate compensation for the survey participant. Such systems can also be used to load information in the data repository 118a in such a way as to be available to survey requestors as described herein while still protecting the individual privacy of the potential survey participant.

The protection of privacy permits an anonymity that many survey participants would prefer. Since the computing server 102 acts as an intermediary between the survey requestor and the survey participant, the survey participant can enjoy an increased level of protection. In some conventional cases, a when survey is presented to an individual directly by a survey requesting entity, the survey requestor possesses a certain level knowledge about the survey participant that may include name, address, email address, telephone number, or other personally identifying pieces of information. In the present embodiments, a survey participant and a survey requestor are matched by computing server 102 and the survey participant's private information can be controlled with some agreed upon level of security.

In other embodiments, some or all of the survey participant profile information is passed via the cellular transceiver 160 of the mobile device 126 to the computing server 102. In these cases, the survey participant profile information can be stored in the data repository 118a and used as described herein.

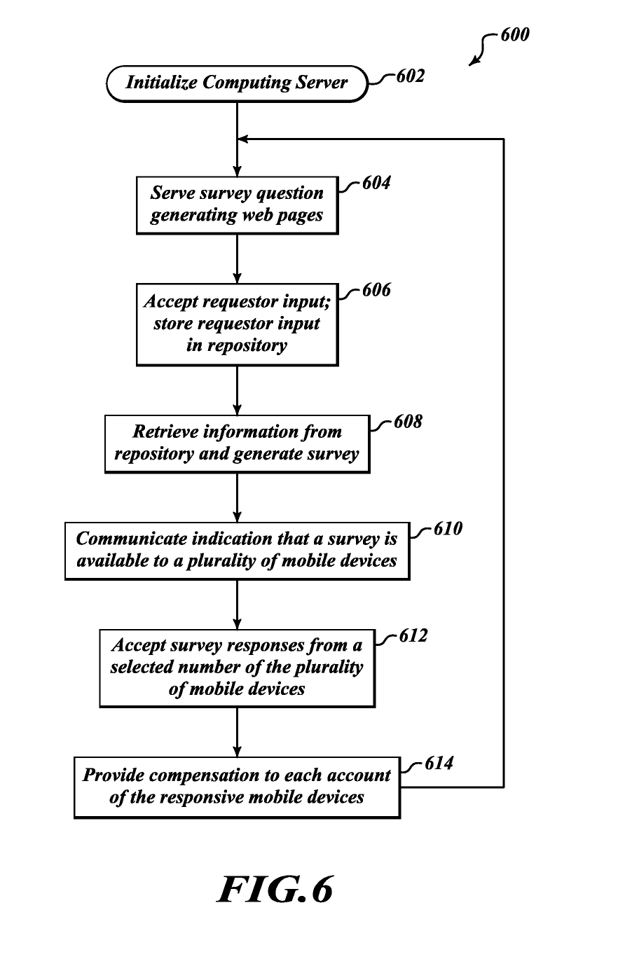

FIG. 6 is a flowchart 600 illustrating processes that may be used by embodiments of a computing server used for performing a survey. In this regard, each process described herein may represent a module, segment, or portion of code, which comprises one or more executable instructions for implementing the specified logical function(s). It should also be noted that in some implementations, the functions noted in the process may occur in a different order, may include additional functions, may occur concurrently, and/or may be omitted.

With respect to FIG. 6, the process 600 is ongoing with operation of a computing server 102, and is illustrated as starting at 602 when the computing server 102 initializes. At 604, operation of the computing server 102 begins serving web pages useful for generating survey questions. Requestor input is accepted at 606 and the requestor input is stored in a repository. Information is retrieved from the repository and used to generate the survey at 608.

At 610, an indication that the survey is available is communicated to a plurality of mobile devices. Independently, the survey questions are answered by users of mobile devices. At 612, survey responses from a selected number of the plurality of mobile devices are accepted. Compensation is provided to an account of each of the plurality of mobile devices that participated in the survey at 614. The process 600 does not typically end, but instead, cyclically returns to the survey question generating web page operation at 604.

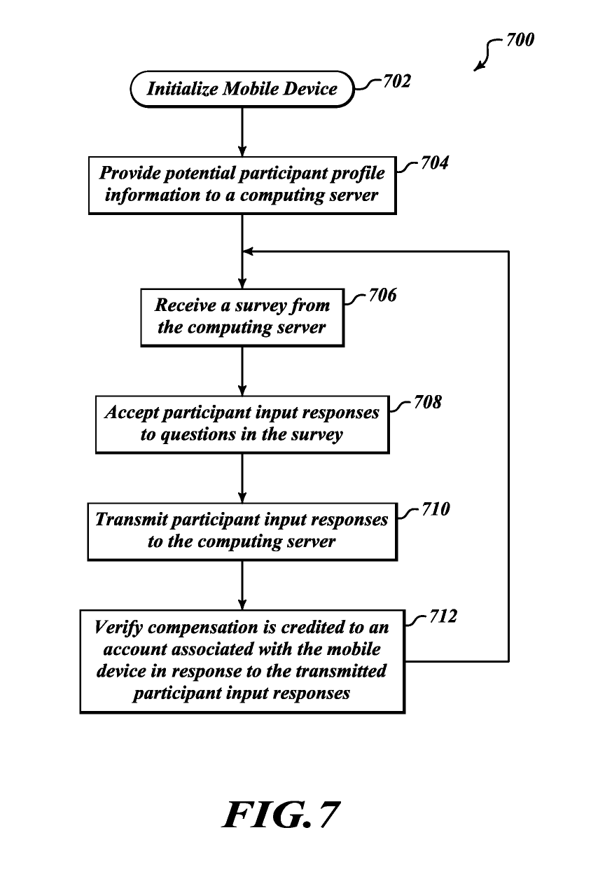

FIG. 7 is a flowchart illustrating a process used by a mobile device embodiment. The process 700 is ongoing with operation of a mobile device 126, and is illustrated as starting at 702 when the mobile device 126 initializes. At 704, operation of the mobile device 126 begins by providing potential survey participant profile information to a computing server 102. A survey is received from the computing server 102 at 706 and participant input responses to survey questions are received at 708. At 710, the participant input responses are transmitted to the computing server 102, and at 712, compensation credited to an account associated with the mobile device is verified. The compensation is in response to the wirelessly transmitted user input responses. The process 700 does not typically end, but instead, cyclically returns to operations at 706 wherein a new survey is received.

A preferred embodiment of the system and method to perform surveys is now described with respect to the figures and other discussions found herein.

A person wanting answers to questions on a given topic, i.e. the survey requestor, creates a secure account on a survey generation website 132, hosted by a web server 102. The website 132 provides a simple requestor interface that guides the survey requestor in creating topic questions. The website 132 further provides a list of potential survey participants segregated by various demographic criteria, for example age, gender, zip code, and the like. The survey requestor selects one or more demographic subsections of interest, and the number of required survey participants. The survey requestor further agrees to pay a selected amount for every completed survey, via preferably an online payment method.

Once the survey generation is complete, the survey is sent, “pushed,” or otherwise made available to the mobile devices 126 of some selected number of potential survey participants that fit the survey requestor's demographic choices. The survey is made available according to potential survey participant's preferred method of contact. Some group of the potential survey participants will answer the survey questions with their mobile device if they choose to. When the requested number of completed surveys has been received, the survey results are compiled and summary and/or complete statistics are provided to the survey requestor. As this is being completed, the survey requestor's payment is accepted and the agreed compensation is sent to each participant. The survey host may keep some share of the requestor's payment or may provide paid advertising to the participants in order to compensate the survey host.

A survey presentation application 156 capable of running on a given mobile communication device 126 is executed. When first run, the survey presentation application 156 requests the potential survey participant to provide answers to several questions relevant to the survey requestor. For example the potential survey participant's age, gender, and zip code. In addition, the survey presentation application 156 will ask on which topics the potential survey participant will be inclined to take a survey. Finally, the survey presentation application 156 will ask for permission from the potential survey participant to allow surveys on such topics to be pushed to the potential survey participant's mobile device 126. The answers to the personal profile questions will be stored in the mobile device memory 158 and sent by the survey presentation application 156 to the web server 102 hosting the survey generation website 132, and be saved in a repository 118a of available survey respondents.

When an available survey is received by a potential survey participant's mobile device 126, the survey presentation application 156 will notify the potential survey participant, for example via a small numerical icon associated with the application, or perhaps with an auditory signal. The potential survey participant, may at will and via the survey presentation application 16, answer the survey questions. When the survey has been completed, the potential survey participant's answers are sent by the survey presentation application 156 to the web server 102.

A survey participant would be immediately reimbursed for completing a survey. Reimbursement in the present embodiment may occur via several methods, however one preferred embodiment is via a monetary credit issued to the survey participant's account at an online music and media store, for example the APPLE ITUNES store. For every completed survey in the present embodiment, the survey participant will receive a predetermined, fixed credit amount such as the value necessary to purchase a single music track from the store.

The number of survey respondents may be limited by the survey requestor. When the selected number of survey responses is received, the survey website 132 can communicate with the survey presentation application 156 of a mobile device 126 that has previously received the survey. The survey presentation application 156 can delete the survey from the mobile device 126 if the survey has not yet been completed. Alternatively, other mechanisms can be used to withdraw the survey from the potential survey participant's mobile device 126.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A method to perform a survey, comprising:
accepting user input in response to a web page configured to solicit input for generating survey questions;
storing the user input in a repository;
generating a survey from information in the repository;
communicating an indication that the survey is available to a plurality of mobile devices;
accepting survey responses from a selected number of the plurality of mobile devices; and
providing compensation to a personal profile account associated with each of the selected number of the plurality of mobile devices.

2. The method of claim 1, further comprising:
accepting personal profile information from a user;
creating the personal profile account to store personal profile information in the repository; and
associating the personal profile account with a particular mobile device.

3. The method of claim 2 wherein communicating the indication to the plurality of mobile devices further comprises:
comparing characteristics of the survey to personal profile information in the personal profile account of each of a plurality of users;
communicating the indication only to mobile devices whose associated personal profile account has personal profile information that matches the characteristics.

4. The method of claim 1 wherein accepting survey responses further comprises:
accepting metadata information, the metadata including how much time was spent on a survey question.

5. The method of claim 1 wherein providing compensation further comprises:
crediting each personal profile account with a song download.

6. The method of claim 1 wherein the compensation provided to each personal profile account is the same compensation.

7. The method of claim 2 wherein the compensation provided to each personal profile account is related to the personal profile information associated with each account.

8. The method of claim 1 wherein generating the survey further comprises:
retrieving information from the repository, the information including user input from a plurality of different users.

9. The method of claim 1, further comprising:
consolidating survey responses from the selected number of the plurality of mobile devices;
storing consolidated survey response information in the repository; and
communicating the consolidated survey response information via a web page.

10. A method to perform a survey with a wireless mobile device, comprising:
providing personal profile information to a computing server;
receiving a survey from the computing server;
accepting user input responses to questions in the survey;
transmitting the user input responses to the computing survey;
verifying compensation credited to an account associated with the mobile device in response to the transmitted user input responses.

11. The method of claim 1 wherein the personal profile information includes identification of the mobile device.

12. The method of claim 1 wherein the personal profile information includes information representing preferred types of surveys, preferred topics of surveys, and when surveys will be received.

13. The method of claim 1 wherein verifying compensation further comprises:
downloading a media file to the mobile device.

14. The method of claim 1, further comprising:
downloading a mobile device survey application file to the mobile device; and
presenting questions in the survey to a user of the mobile device with the mobile device survey application.

15. The method of claim 14 wherein presenting questions in the survey includes configuring a display, configuring an illumination output, configuring an audio device, and configuring a vibrating device.

16. A computer-readable medium whose contents configure a computing platform to perform a survey, by performing a method comprising:
delivering first information to a user, the first information related to the acceptance of survey topics and questions to be asked on a survey;
accepting second information from the user, the second information selecting a survey topic and selecting questions to be asked;
generating the survey from the selected survey topic and the selected questions to be asked;
communicating the survey to selected computing devices;
accepting survey responses from at least some of the selected computing devices;
crediting an account associated with each of the at least some of the selected computing devices with a selected compensation; and
communicating third information related to the survey responses to the user.

17. The computer-readable medium of claim 16 wherein delivering the first information includes presenting a software wizard configured to assist the user to develop the questions to be asked on the survey.

18. The computer-readable medium of claim 16 wherein delivering the first information includes communicating the first information to a business purpose computing device.

19. The computer-readable medium of claim 18 wherein the user of the business purpose computing device is an employee of a business that administers the business purpose computing device.

20. The computer-readable medium of claim 16 wherein the user is a business customer.
